(19) United States
(12) Patent Application Publication
(10) Pub. No.: US 2012/0317768 A1
(43) Pub. Date: Dec. 20, 2012

(54) LATERAL PIN EXTRACTION TOOL AND LATERAL PIN EXTRACTION TOOL SET FOR WORKING MACHINE BUCKET

(76) Inventor: Kiyoshi Watanabe, Nagaoka-shi (JP)

(21) Appl. No.: 13/331,378

(22) Filed: Dec. 20, 2011

(30) Foreign Application Priority Data
Jun. 17, 2011 (JP) 2011-134711

(51) Int. Cl. B25B 27/14

(52) U.S. Cl. 29/275

(57) ABSTRACT

A lateral pin extraction tool for extracting a lateral pin fitted into respective lateral holes penetrating a plurality of adapters and a plurality of points, respectively, in a working machine bucket, comprising: an extraction butting element, the distal end thereof being butted against the end part of the lateral pin fitted into the lateral hole while, under the striking force, being inserted into the lateral hole for extracting the lateral pin fitted into the lateral hole; and a striking block element integrally provided at the proximal end of the extraction butting element for receiving the striking force to transmit it to the extraction butting element; and a shank element for grip equipped with a slip prevention part integrally mounted to the striking block element, the protrusion length of the extraction butting element from the striking block element being set at any length of extra long, long, medium, and short.

### TECHNICAL FIELD

The present invention relates to a lateral pin extraction tool and a lateral pin extraction tool set for a working machine bucket that assure safety and accuracy of lateral pin extraction operation when making an operation of extraction of lateral pins from the working machine bucket, and yet assure improvement of the operation efficiency.

### BACKGROUND ART

With various buckets for use by mounting to a working machine, such as a power shovel, a shovel loader, or the like, the rear parts of a plurality of tooth points (including a tooth edge; hereinafter the same shall apply) on the ground-leveling plate side are fitted to a plurality of (for example, four or five) adapters (metal fittings) disposed in a row, being equally spaced, on the ground excavation edge part side of the bucket, respectively, a lateral pin being fitted into the respective lateral holes (through-holes) penetrating through the adapter and the pertinent tooth point, thereby the tooth point being fixedly installed to the adapter so as to be removable.

In this case, when, for example, removing the respective points from the adapters, it is required to make a lateral pin extraction operation by manpower. To do this, conventionally, a cylinder-shaped tool, such as a crowbar, is applied to the end of a lateral pin, being held by one hand, and the cylinder-shaped tool is struck with a hammer, or the like, held by the other hand such that the lateral pin is extracted from the through-hole (as shown in FIG. 5 in Patent Document 1).

However, in case of such an lateral pin extraction operation, because the dimension of the cylinder-shaped tool is short, there is a possibility of that, for example, the force with which the striking end part is struck by the hammer may not be directly transmitted to the pin; the tool is displaced at the striking by the hammer; or further, the spacing between the face of the operator and the hammer striking end part of the cylinder-shaped tool may be reduced, resulting in occurrence of such a wretched state as the face of the operator, the glasses thereof, or the like, being struck by the hammer, which can lead to an injury, such as a blow, a fracture, or the like. Such a state will not be avoided even if the operator wears a face protector.

### PATENT DOCUMENT

Patent Document 1: Japanese Unexamined Patent Application Publication No. 2006-125083

### DISCLOSURE OF THE INVENTION

### Problems to be Solved by the Invention

The problem to be solved by the present invention lies in that there exists no lateral pin extraction tools for working machine bucket that assure safety and accuracy of lateral pin extraction operation, and yet assure improvement of the operation efficiency, especially contributing to improvement of the operational safety, when used for a lateral pin extraction operation.

### Means for Solving the Problems

The present invention provides, as a most important feature thereof, a lateral pin extraction tool for extracting a lateral pin fitted into respective lateral holes penetrating a plurality of adapters and a plurality of points, respectively, in a working machine bucket, comprising: an extraction butting element, the distal end thereof being butted against the end part of the lateral pin fitted into the lateral hole; a striking block element integrally provided at the proximal end of the extraction butting element for receiving the striking force to transmit it to the extraction butting element; and a shank element for grip which is integrally mounted to the striking block element, and has a slip prevention part in the circumferential portion of the end part, the length of the shank element for grip being considerably “extra long”, as compared to this type of conventional tools, the protrusion length of the extraction butting element from the striking block element being set at any of a plurality of grades of length from longest to shortest in the range of the arrangement width for a plurality of adapters in the working machine bucket, preferably, four grades of length from longest to shortest constituted by a grade of length allowing insertion into the respective lateral holes in all the adapters and points; a grade of length allowing insertion into the respective lateral holes of three or four adapters and points; a grade of length allowing insertion into the respective lateral holes of two adapters and points; and a grade of length allowing insertion into the lateral hole of one adapter and point.

### Advantages of the Invention

According to the invention as stated in claim 1, the length of the shank element for grip is considerably “extra long”, as compared to this type of conventional tools, and the protrusion length of the lateral pin extraction tool itself from the portion of the rear end face of the extraction butting element that is struck by a hammer is set at any of a plurality of grades of length from longest to shortest in the range of the arrangement width for a plurality of adapters in the working machine bucket, preferably, any of four grades of length from longest to shortest consisting of a grade of length allowing insertion into the respective lateral holes in all the adapters and points; a grade of length allowing insertion into the respective lateral holes of three or four adapters and points; a grade of length allowing insertion into the respective lateral holes of two adapters and points; and a grade of length allowing insertion into the lateral hole of one adapter and point, which, in making a lateral pin extraction operation, allows proper selection from the lateral pin extraction tools different in protrusion length of the extraction butting element, assuring safety and accuracy of the lateral pin extraction operation and yet assuring improvement of the operation efficiency.

According to the invention as stated in claim 2, the length of the shank element for grip is considerably “extra long”, as compared to this type of conventional tools, and the protrusion length of the lateral pin extraction tool itself from the portion of the rear end face of the extraction butting element that is struck by a hammer is set at any of lengths, i.e., extra long, long, medium, and short lengths in the range of the arrangement width for a plurality of adapters in the working machine bucket, preferably, any of lengths, i.e., an extra long length defined as a grade of length allowing insertion into the respective lateral holes in all the adapters and points; a long length defined as a grade of length allowing insertion into the respective lateral holes of three or four adapters and points; a medium length defined as a grade of length allowing insertion into the respective lateral holes of two adapters and points; and a short length defined as a grade of length allowing insertion into the lateral hole of one adapter and point, which, as is the case with the invention as stated in claim 1, in making a lateral pin extraction operation, allows proper selection from the lateral pin extraction tools different in protrusion length of the extraction butting element, assuring safety and accuracy of the lateral pin extraction operation and yet assuring improvement of the operation efficiency.

The invention as stated in claim 3 provides the same advantages as those of the invention as stated in claim 2, and further, an auxiliary shank element equipped with a slip prevention part for increasing the shank length is added, which can contribute to improvement of the operational safety as well.

According to the invention as stated in claim 4, the length of the shank element for grip is considerably “extra long”, as compared to this type of conventional tools, and the protrusion length from the portion of the rear end face of the extraction butting element that is struck by a hammer is set at any of a plurality of grades of length from longest to shortest in the range substantially equivalent to the arrangement width for a plurality of adapters in the working machine bucket, preferably, any of four grades of length from longest to shortest consisting of a grade of length allowing insertion into the respective lateral holes in all the adapters and points; a grade of length allowing insertion into the respective lateral holes of three or four adapters and points; a grade of length allowing insertion into the respective lateral holes of two adapters and points; and a grade of length allowing insertion into the lateral hole of one adapter and point, which allows proper selection of lateral pin extraction tool, assuring safety and accuracy of the lateral pin extraction operation and yet assuring improvement of the operation efficiency.

According to the invention as stated in claim 5, the length of the shank element for grip is considerably “extra long”, as compared to this type of conventional tools, and the protrusion length from the portion of the rear end face of the extraction butting element that is struck by a hammer is set at any of lengths, i.e., extra long, long, medium, and short lengths in the range substantially equivalent to the arrangement width for a plurality of adapters in the working machine bucket, preferably, any of lengths, i.e., an extra long length defined as a grade of length allowing insertion into the respective lateral holes in all the adapters and points; a long length defined as a grade of length allowing insertion into the respective lateral holes of three or four adapters and points; a medium length defined as a grade of length allowing insertion into the respective lateral holes of two adapters and points; and a short length defined as a grade of length allowing insertion into the lateral hole of one adapter and point, which allows proper selection of lateral pin extraction tool, assuring safety and accuracy of the lateral pin extraction operation and yet assuring improvement of the operation efficiency.

The invention as stated in claim 6 provides the same advantages as those of the invention as stated in claim 5, and further, an auxiliary shank element equipped with a slip prevention part for increasing the shank length is added to the respective lateral pin extraction tools, which can contribute to further improvement of the operational safety as well.

According to the invention as stated in claim 7, the length of the shank element for grip is considerably “extra long”, as compared to this type of conventional tools, and the protrusion length of the lateral pin extraction tool itself from the striking block element of the extraction butting element is set at any of a plurality of grades of length from longest to shortest in the range of the arrangement width for a plurality of adapters in the working machine bucket, preferably, any of four grades of length from longest to shortest consisting of a grade of length allowing insertion into the respective lateral holes in all the adapters and points; a grade of length allowing insertion into the respective lateral holes of three or four adapters and points; a grade of length allowing insertion into the respective lateral holes of two adapters and points; and a grade of length allowing insertion into the lateral hole of one adapter and point, which, in making a lateral pin extraction operation, allows proper selection from the lateral pin extraction tools different in protrusion length of the extraction butting element, assuring safety and accuracy of the lateral pin extraction operation and yet assuring improvement of the operation efficiency.

According to the invention as stated in claim 8, the length of the shank element for grip is considerably “extra long”, as compared to this type of conventional tools, and the protrusion length of the lateral pin extraction tool itself from the striking block element of the extraction butting element is set at any of lengths, i.e., extra long, long, medium, and short lengths in the range of the arrangement width for a plurality of adapters in the working machine bucket, preferably, any of lengths, i.e., an extra long length defined as a grade of length allowing insertion into the respective lateral holes in all the adapters and points; a long length defined as a grade of length allowing insertion into the respective lateral holes of three or four adapters and points; a medium length defined as a grade of length allowing insertion into the respective lateral holes of two adapters and points; and a short length defined as a grade of length allowing insertion into the lateral hole of one adapter and point, which, as is the case with the invention as stated in claim 7, in making a lateral pin extraction operation, allows proper selection from the lateral pin extraction tools different in protrusion length of the extraction butting element, assuring safety and accuracy of the lateral pin extraction operation and yet assuring improvement of the operation efficiency.

The invention as stated in claim 9 provides the same advantages as those of the invention as stated in claim 8, and further, an auxiliary shank element equipped with a slip prevention part for increasing the shank length is added, which can contribute to improvement of the operational safety as well.

According to the invention as stated in claim 10, the length of the shank element for grip is considerably “extra long”, as compared to this type of conventional tools, and the protrusion length of the extraction butting element from the striking block element is set at any of a plurality of grades of length from longest to shortest in the range substantially equivalent to the arrangement width for a plurality of adapters in the working machine bucket, preferably, any of four grades of length from longest to shortest consisting of a grade of length allowing insertion into the respective lateral holes in all the adapters and points; a grade of length allowing insertion into the respective lateral holes of three or four adapters and points; a grade of length allowing insertion into the respective lateral holes of two adapters and points; and a grade of length allowing insertion into the lateral hole of one adapter and point, which allows proper selection of lateral pin extraction tool, assuring safety and accuracy of the lateral pin extraction operation and yet assuring improvement of the operation efficiency.

According to the invention as stated in claim 11, a collection of four lateral pin extraction tools is provided, the length of the shank element for grip being considerably “extra long”, as compared to this type of conventional tools, and the protrusion length of the extraction butting element from the striking block element being set at any of lengths, i.e., extra long, long, medium, and short lengths in the range substantially equivalent to the arrangement width for a plurality of adapters in the working machine bucket, preferably, any of lengths, i.e., an extra long length defined as a grade of length allowing insertion into the respective lateral holes in all the adapters and points; a long length defined as a grade of length allowing insertion into the respective lateral holes of three or four adapters and points; a medium length defined as a grade of length allowing insertion into the respective lateral holes of two adapters and points; and a short length defined as a grade of length allowing insertion into the lateral hole of one adapter and point, which allows proper selection of lateral pin extraction tool, assuring safety and accuracy of the lateral pin extraction operation and yet assuring improvement of the operation efficiency.

The invention as stated in claim 12 provides the same advantages as those of the invention as stated in claim 11, and further, an auxiliary shank element equipped with a slip prevention part for increasing the shank length is added to the respective lateral pin extraction tools, which can contribute to further improvement of the operational safety as well.

### BRIEF DESCRIPTION OF THE DRAWINGS FOR THE FIRST INVENTION

FIG. 1 is a schematic front view of a lateral pin extraction tool set for a working machine bucket according to an embodiment 1 of the present invention;

FIG. 2 is a drawing giving a front view, a top view, a bottom view, and right and left side views of the lateral pin extraction tool constituting the lateral pin extraction tool set for the working machine bucket according to the embodiment 1, the extraction butting element thereof having an extra long dimension;

FIG. 3 is a drawing giving a front view, a top view, a bottom view, and right and left side views of the lateral pin extraction tool constituting the lateral pin extraction tool set for the working machine bucket according to the embodiment 1, the extraction butting element thereof having an extra long dimension;

FIG. 4 is a drawing giving a front view, a top view, a bottom view, and right and left side views of the lateral pin extraction tool constituting the lateral pin extraction tool set for the working machine bucket according to the embodiment 1, the extraction butting element thereof having a medium dimension;

FIG. 5 is a drawing giving a front view, a top view, a bottom view, and right and left side views of the lateral pin extraction tool constituting the lateral pin extraction tool set for the working machine bucket according to the embodiment 1, the extraction butting element thereof having a short dimension;

FIG. 6 is a schematic explanation view illustrating a lateral pin extraction operation by means of the lateral pin extraction tool according to the embodiment 1;

FIG. 7 is a schematic front view of a lateral pin extraction tool set for a working machine bucket according to an embodiment 2 of the present invention;

FIG. 8 is an explanation view illustrating an assembled state of a lateral pin extraction tool constituting the lateral pin extraction tool set for the working machine bucket according to the embodiment 2, the extraction butting element thereof having an extra long dimension with an auxiliary shank element being added;

FIG. 9 is an explanation view illustrating an assembled state of a lateral pin extraction tool constituting the lateral pin extraction tool set for the working machine bucket according to the embodiment 2, the extraction butting element thereof having a long dimension with an auxiliary shank element being added;

FIG. 10 is an explanation view illustrating an assembled state of a lateral pin extraction tool constituting the lateral pin extraction tool set for the working machine bucket according to the embodiment 2, the extraction butting element thereof having a medium dimension with an auxiliary shank element being added;

FIG. 11 is an explanation view illustrating an assembled state of a lateral pin extraction tool constituting the lateral pin extraction tool set for the working machine bucket according to the embodiment 2, the extraction butting element thereof having a short dimension with an auxiliary shank element being added;

FIG. 12 is a schematic explanation view illustrating a lateral pin extraction operation by means of the lateral pin extraction tool according to the embodiment 2; and

FIG. 13 is a drawing giving a front view, a top view, a bottom view, and right and left side views of a lateral pin extraction tool constituting the lateral pin extraction tool set for the working machine bucket according to the embodiment 1, the extraction butting element thereof having an extra long dimension, and the extraction butting element and shank element thereof being formed as an integral part without any striking block element being provided, thereby a modification being given.

### BEST MODE FOR CARRYING OUT THE PRESENT INVENTION

The present invention is intended to realize and provide a lateral pin extraction tool for a working machine bucket which assures safety and accuracy of the lateral pin extraction operation and yet assures improvement of the operation efficiency, especially contributing to improvement of operational safety, when used for a lateral pin extraction operation, and it has achieved this purpose with a lateral pin extraction tool for extracting a lateral pin fitted into respective lateral holes penetrating a plurality of adapters and a plurality of points, respectively, in a working machine bucket, comprising: an extraction butting element, the distal end thereof being butted against the end part of the lateral pin fitted into the lateral hole; a striking block element integrally provided at the proximal end of the extraction butting element for receiving the striking force to transmit it to the extraction butting element; and a shank element for grip equipped with a slip prevention part, being integrally mounted to the striking block element, and an auxiliary shank element equipped with a slip prevention part for increasing the shank length, being removably mounted to this shank element, the protrusion length of the extraction butting element from the striking block element being set at any of the lengths, extra long, long, medium, and short, in the range substantially equivalent to the arrangement width for a plurality of adapters in the working machine bucket, preferably, any of a grade of length, extra long, allowing insertion into the respective lateral holes in all the adapters and points; a grade of length, long, allowing insertion into the respective lateral holes of three or four adapters and points; a grade of length, medium, allowing insertion into the respective lateral holes of two adapters and points; and a grade of length, short, allowing insertion into the lateral hole of one adapter and point.

### Embodiments

Hereinbelow, lateral pin extraction tools and lateral pin extraction tool sets for a working machine bucket according to embodiments of the present invention will be described in detail with reference to the drawings.

### Embodiment 1

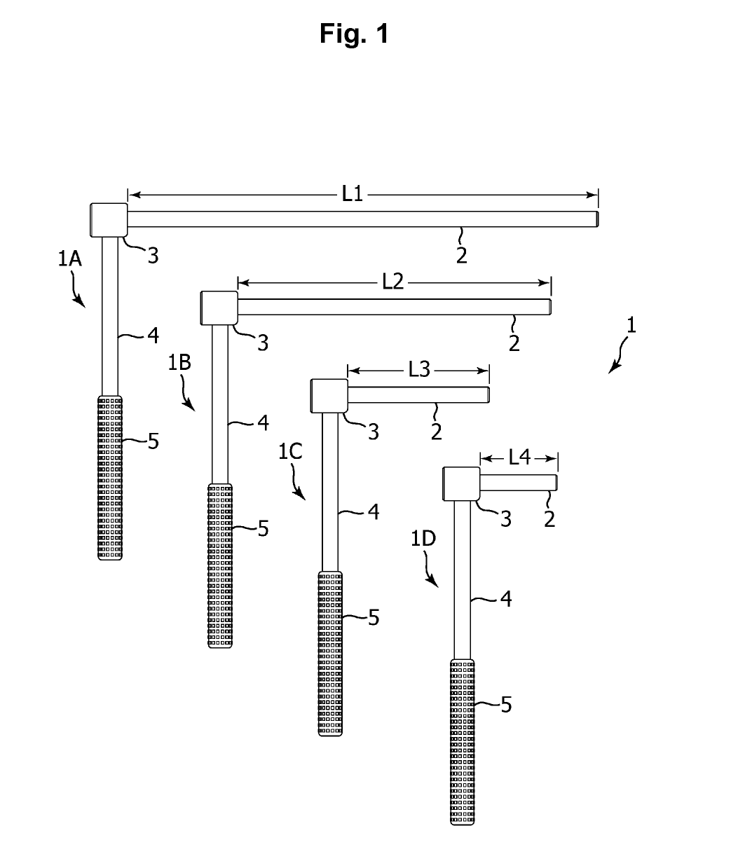

With reference to FIG. 1 to FIG. 6, lateral pin extraction tools and a lateral pin extraction tool set for a working machine bucket according to an embodiment 1 of the present invention will be described.

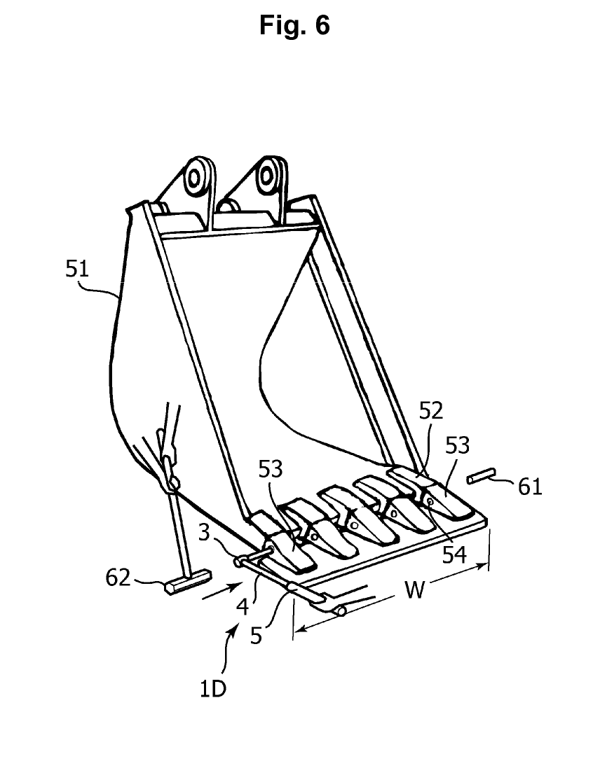

A lateral pin extraction tool set 1 for a working machine bucket 51 according to the embodiment 1 of the present invention is used for extracting a lateral pin 61 fitted into each lateral hole 54 penetrating a plurality of adapters 52 and a plurality of points 53, respectively, in the working machine bucket 51 as shown in FIG. 6, and as shown in FIG. 1, is constituted by lateral pin extraction tools 1A to 1D, four in total, formed of such a material as steel or the like.

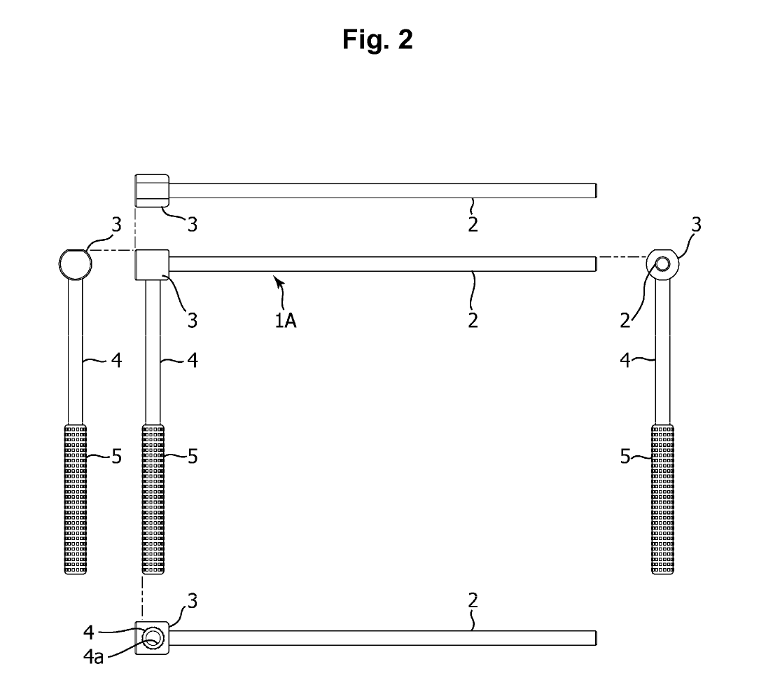

As shown in FIG. 2, the lateral pin extraction tool 1A includes an extraction butting element 2 in the shape of a round bar, for example, the protrusion end of which is butted against the end part of the lateral pin 61 fitted into the lateral hole 54; a striking block element 3 formed in the shape of a cylinder, having an outside diameter of 50 mm or so, for example, that is provided at the proximal end of this extraction butting element 2 integrally as a whole to receive the striking force by a hammer 62, for example, and transmit the force to the extraction butting element 2; and a shank element for grip 4 in the shape of a round bar, for example, which is mounted to this striking block element 3 integrally as a whole, and has a slip prevention part 5 in the circumferential portion of the end part.

The length of the shank element for grip 4 is defined to be considerably “extra long”, as compared to this type of conventional tools, with the protrusion length L1 of the extraction butting element 2 from the striking block element 3 thereof being defined to be considerably “extra long”, as compared to this type of conventional tools, in the range equivalent to, for example, the arrangement width W for the plurality of adapters 52 in the working machine bucket 51.

The extraction butting element 2 may be formed in the shape of a polygon rather than a round bar as shown, the striking block element 3 may be formed in the shape of a polygon rather than a cylinder as shown; and further, the outside diameter of the striking block element 3 is not limited to 50 mm. In addition, the shank element for grip 4 may be formed in the shape of a polygon rather than a round bar as shown.

The extraction butting element 2, striking block element 3 and shank element 4 are configured to provide an L-shape as a whole, being formed as an integral part as a whole by welding, for example.

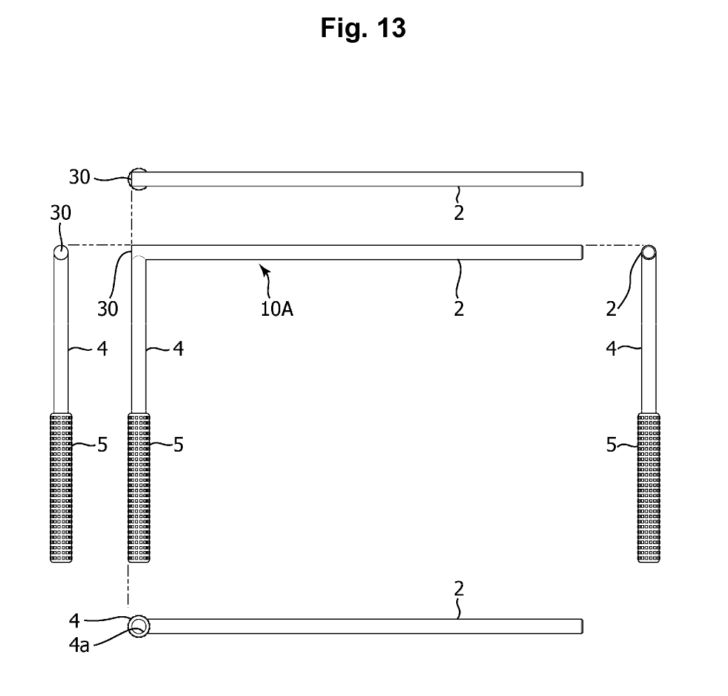

Alternatively to a configuration as illustrated in the figure (a configuration providing an integral part as a whole by welding), the extraction butting element 2, striking block element 3 and shank element 4 may be configured to provide a modification as shown in FIG. 13 by forming the extraction butting element 2 and the shank element 4 as an integral part without the striking block element 3 being provided.

FIG. 13 is a drawing giving a front view, a top view, a bottom view, and right and left side views of a lateral pin extraction tool 10A, which is the same as the lateral pin extraction tool 1A constituting the lateral pin extraction tool set for a working machine bucket according to the embodiment 1, the extraction butting element 2 thereof having an extra long dimension, except for the extraction butting element 2 and shank element 4 thereof being formed as an integral part, thereby a modification being given. The reference numeral 30 in FIG. 13 denotes the rear end face of the extraction butting element 2 that replaces the striking block element 3, indicating the portion which is struck by the hammer. The lateral pin extraction tools 1B, 1C, and 1D may be configured by forming the extraction butting element 2 and the shank element 4 as an integral part, without providing the striking block element 3.

Further, alternatively to the configuration of the extraction butting element 2, striking block element 3 and shank element 4 in which the shank element 4 is located approximately just under the striking block element 3 (or the portion 30 of the rear end face of the extraction butting element 2 that is struck by the hammer, shown in FIG. 13) to provide substantially an L-shaped configuration as a whole, as illustrated in the figure, a configuration may be adopted in which, instead of locating the shank element 4 just under the striking block element 3 (or the portion 30 of the rear end face of the extraction butting element 2 that is struck by the hammer, shown in FIG. 13) as illustrated in the figure, the shank element 4 is located, as an integral part as a whole, on the lower end face of the extraction butting element 2 with an appropriate distance being given from the striking block element 3 (or the portion 30 of the rear end face of the extraction butting element 2 that is struck by the hammer, shown in FIG. 13), thus a modified shape of T (not shown) being provided.

The bottom part of the shank element 4 is provided with an internally threaded part 4a for screwing-in or screwing-out of an auxiliary shank element 11 later described.

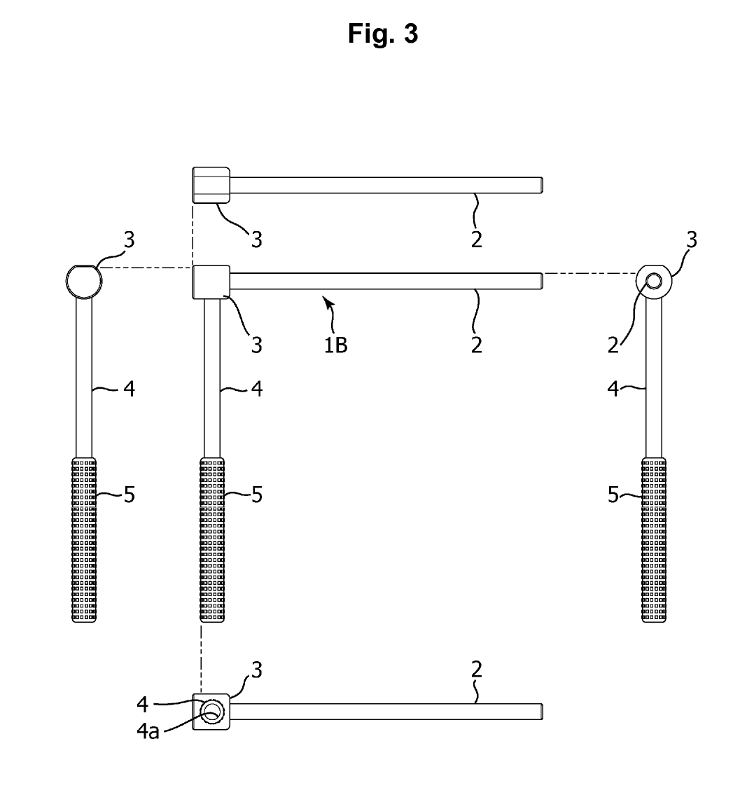

The lateral pin extraction tool 1B has substantially the same configuration as that of the lateral pin extraction tool 1A as shown in FIG. 3, the protrusion length L2 of the extraction butting element 2 from the striking block element 3 being defined to be of a “long” dimension, which is a little shorter than the protrusion length L1 of the lateral pin extraction tool 1A.

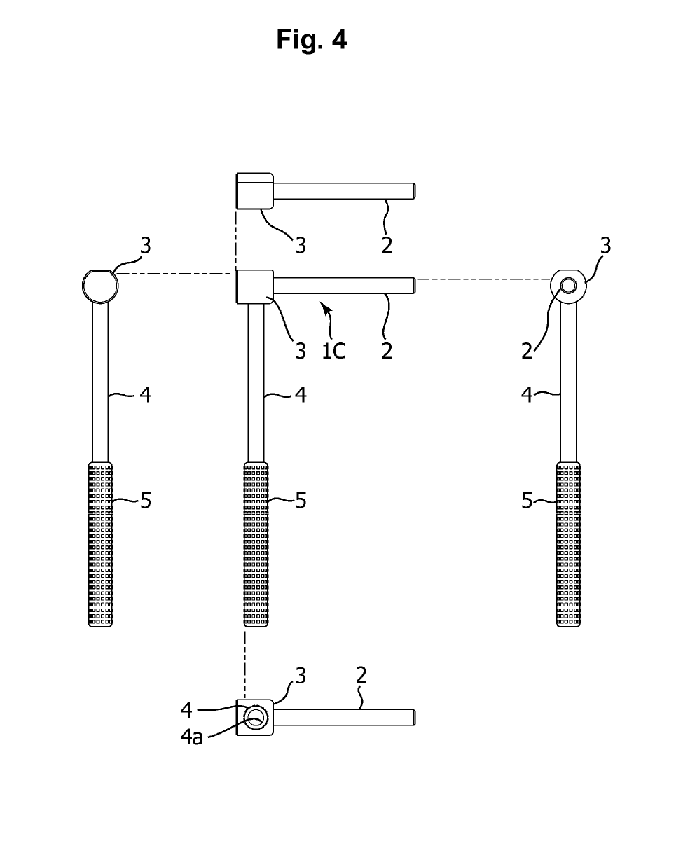

The lateral pin extraction tool 1C has substantially the same configuration as that of the lateral pin extraction tool 1B as shown in FIG. 4, the protrusion length L3 of the extraction butting element 2 from the striking block element 3 being defined to be of a “medium” dimension, which is a little shorter than the protrusion length L2 of the lateral pin extraction tool 1B.

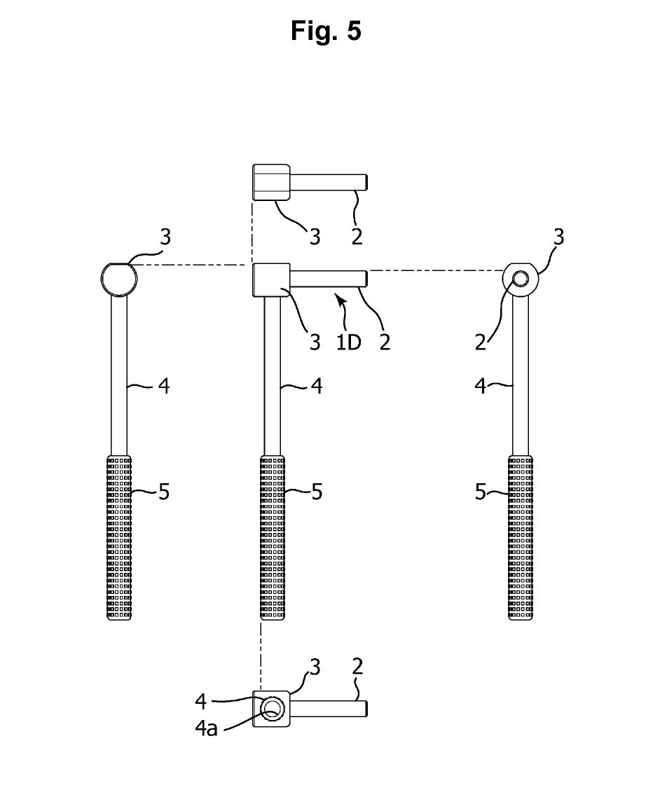

The lateral pin extraction tool 1D has substantially the same configuration as that of the lateral pin extraction tool 1C as shown in FIG. 5, the protrusion length L4 of the extraction butting element 2 from the striking block element 3 being defined to be of a “short” dimension, which is a little shorter than the protrusion length L3 of the lateral pin extraction tool 1C.

In other words, the protrusion length of the respective extraction butting elements 2 from the striking block element 3 is defined so as to meet the relationship among the respective protrusion lengths L1 to L4 of the respective lateral pin extraction tools 1A to 1D, i.e., L1>L2>L3>L4.

The relationship among the respective protrusion lengths L1 to L4 of the respective lateral pin extraction tools 1A to 1D will be here described in detail. In the range of the arrangement width for the plurality of adapters in the working machine bucket, the protrusion length L1 of the lateral pin extraction tool 1A is defined to be extra long as a grade of length which permits insertion into all the lateral holes in all the adapters and points; the protrusion length L2 of the lateral pin extraction tool 1B is defined to be long as a grade of length which permits insertion into the respective lateral holes in three or four adapters and points.

In other words, in the range of the arrangement width for the plurality of adapters in the working machine bucket, the protrusion length L1 of the lateral pin extraction tool 1A is defined to be extra long as a grade of length which permits, for example, extraction of the respective lateral pins fitted into the respective lateral holes in all the adapters and points; the protrusion length L2 of the lateral pin extraction tool 1B is defined to be long as a grade of length which permits, for example, extraction of the respective lateral pins fitted into the respective lateral holes in three or four adapters and points; the protrusion length L3 of the lateral pin extraction tool 1C is defined to be medium as a grade of length which permits, for example, extraction of the lateral pins fitted into the respective lateral holes in two adapters and points; and the protrusion length L4 of the lateral pin extraction tool 1D is defined to be short as a grade of length which permits extraction of the lateral pin fitted into the lateral hole in one adapter and point.

Next, the lateral pin extraction operation using any of the lateral pin extraction tools 1A to 1D according to the embodiment 1 will be described with reference to FIG. 6 (illustrating the operation made by two persons).

FIG. 6 illustrates the state in which the lateral pin extraction operation is made by two persons, however, when any of the lateral pin extraction tools 1A to 1D according to the embodiment 1 is used, the lateral pin extraction operation can, of course, be made by a single person. In case where the lateral pin extraction operation is made by a single person, one hand of the operator holds the shank element 4 of the lateral pin extraction tool, the other hand having the hammer 62, and further, locating the protrusion end of the extraction butting element 2 of the lateral pin extraction tool in the lateral hole 54 for butting it against the lateral pin 61.

In the embodiment 1, in order to extract the lateral pin 61 fitted into the respective lateral holes 54 penetrating the plurality of adapters 52 and the plurality of points 53 in the working machine bucket 51, an appropriate one of the four lateral pin extraction tools 1A to 1D constituting the lateral pin extraction tool set 1 is selected for use.

For example, in order to extract a first lateral pin 61 (located on the outermost side) of the respective lateral pins 61 fitted into the plurality of lateral holes 54 in the working machine bucket 51, it is advantageous to select the lateral pin extraction tool 1D of the four lateral pin extraction tools 1A to 1D, judging from the relationship between the length of the protrusion length L4 of the extraction butting element 2 and that of the shank element 4.

FIG. 6 illustrates the state in which the operation is made by two persons confronting each other, for example, one operator holding the shank element 4 of the lateral pin extraction tool 1D by both hands, the other operator having the hammer 62 by both hands, and further locating the protrusion end of the extraction butting element 2 of the lateral pin extraction tool 1D in the lateral hole 54 for butting it against the lateral pin 61.

In other words, the protrusion end of the extraction butting element 2 of the lateral pin extraction tool 1D is butted against the end part of the lateral pin 61 fitted into the lateral hole 54.

In this state, the operator uses the hammer 62 to strike the striking block element 3 of the lateral pin extraction tool 1D.

Thereby, the force is transmitted from the striking block element 3 to the extraction butting element 2, the lateral pin 61 in the lateral hole 54 being forced out of this lateral hole 54 to be extracted.

In case where such lateral pin extraction tool 1D is used, because the length of the shank element 4 is defined to be considerably “extra long”, as compared to this type of conventional tools, the operation can be made with a considerably large spacing being given between the position of the operator's face and the extraction butting element 2 for the lateral pin, which assures safety of the lateral pin extraction operation.

Concurrently, the protrusion length L4 of the extraction butting element 2 of this lateral pin extraction tool 1D being short makes the lateral pin extraction tool 1D suitable for extraction of the lateral pin 61 in, for example, one lateral hole 54 in the working machine bucket 51, and allows the striking operation by the hammer 62 on the lateral pin extraction tool 1D to be made accurately without misalignment, which assures accuracy of the lateral pin extraction operation, and improvement of the operation efficiency.

In this case, after completion of the extraction of the lateral pin 61 in one lateral hole 54 located on the outermost side in the working machine bucket 51 as described above, the extraction butting element 2 of the lateral pin extraction tool 1C, which is subsequently used, is passed through the pertinent lateral hole 54, which can function as a guide, to extract a second lateral pin 61 and the like, which assures a higher accuracy of the lateral pin extraction operation and a further improvement of the operation efficiency. This same statement is applicable to use of the lateral pin extraction tool 1B and the lateral pin extraction tool 1A.

Next, the state in which two persons make operation using the lateral pin extraction tool 1A will be described.

In this case, one operator holds, for example, the shank element 4 of the lateral pin extraction tool 1A by both hands, and the other operator has the hammer 62 by both hands, further, passing the protrusion end of the extraction butting element 2 of the lateral pin extraction tool 1A through the respective lateral holes 54 from which the respective lateral pins 61 have been extracted by the lateral pin extraction tools 1D, 1C, and 1B, and then butting the protrusion end of the extraction butting element 2 against the lateral pin 61 to be extracted while making a striking operation on the lateral pin extraction tool 1A by the hammer 62 for extraction of the lateral pin.

In case where two persons make operation using the lateral pin extraction tool 1A, because the protrusion length L1 of the extraction butting element 2 of the lateral pin extraction tool 1A is extra long, the extraction operation on the five, for example, lateral pins 61 fitted into the respective lateral holes 54 penetrating the five, for example, adapters 52 and points 53, respectively, can be made at a time by means of the lateral pin extraction tool 1A, which assures improvement of the operation efficiency.

In case where either of the lateral pin extraction tool 1C and the lateral pin extraction tool 1B, which are between the aforementioned lateral pin extraction tool 1D and lateral pin extraction tool 1A, is used, the lateral pin extraction tool 1C, for example, can provide substantially the same functional effects (improvement in safety and accuracy) as is obtained with the lateral pin extraction tool 1D, while the lateral pin extraction tool 1B, for example, can provide substantially the same functional effect (improvement in operation efficiency) as is obtained with the lateral pin extraction tool 1A.

In this way, if a second lateral pin 61 (next to the first lateral pin 61 located on the outermost side) of the respective lateral pins 61 fitted into the plurality of lateral holes 54 in the working machine bucket 51 is to be extracted, for example, the operator can advantageously select the lateral pin extraction tool 1C of the four lateral pin extraction tools 1A to 1D, judging from the relationship between the length of the protrusion length L3 of the extraction butting element 2 and that of the shank element 4; if a third lateral pin 61 (next to the second lateral pin 61) of the respective lateral pins 61 fitted into the plurality of lateral holes 54 in the working machine bucket 51 is to be extracted, for example, the operator can advantageously select the lateral pin extraction tool 1B of the four lateral pin extraction tools 1A to 1D, judging from the relationship between the length of the protrusion length L2 of the extraction butting element 2 and that of the shank element 4; and further, if a fourth lateral pin 61 (next to the third lateral pin 61) of the respective lateral pins 61 fitted into the plurality of lateral holes 54 in the working machine bucket 51 is to be extracted, for example, the operator can advantageously select the lateral pin extraction tool 1A of the four lateral pin extraction tools 1A to 1D, judging from the relationship between the length of the protrusion length L1 of the extraction butting element 2 and that of the shank element 4.

The protrusion length L4 of the extraction butting element 2 of the lateral pin extraction tool 1D is preferably long enough not to cause any interference with the side cutter (not shown in FIG. 6) of the working machine bucket 51.

Further, the lateral pin extraction tool set 1 for the working machine bucket 51 according to the embodiment 1 is constituted by the lateral pin extraction tools 1A to 1D, four in total, as shown in FIG. 1, which allows proper selection of lateral pin extraction tool, assuring safety and accuracy of the lateral pin extraction operation, and improvement of the operation efficiency.

In the embodiment 1, the lateral pin extraction tool set 1 is constituted by the lateral pin extraction tools 1A to 1D, four in total, however, the constitution is not restricted to this, and a lateral pin extraction tool set 1 which is constituted by a desired combination of selections from these respective lateral pin extraction tools can, of course, be provided.

### Embodiment 2

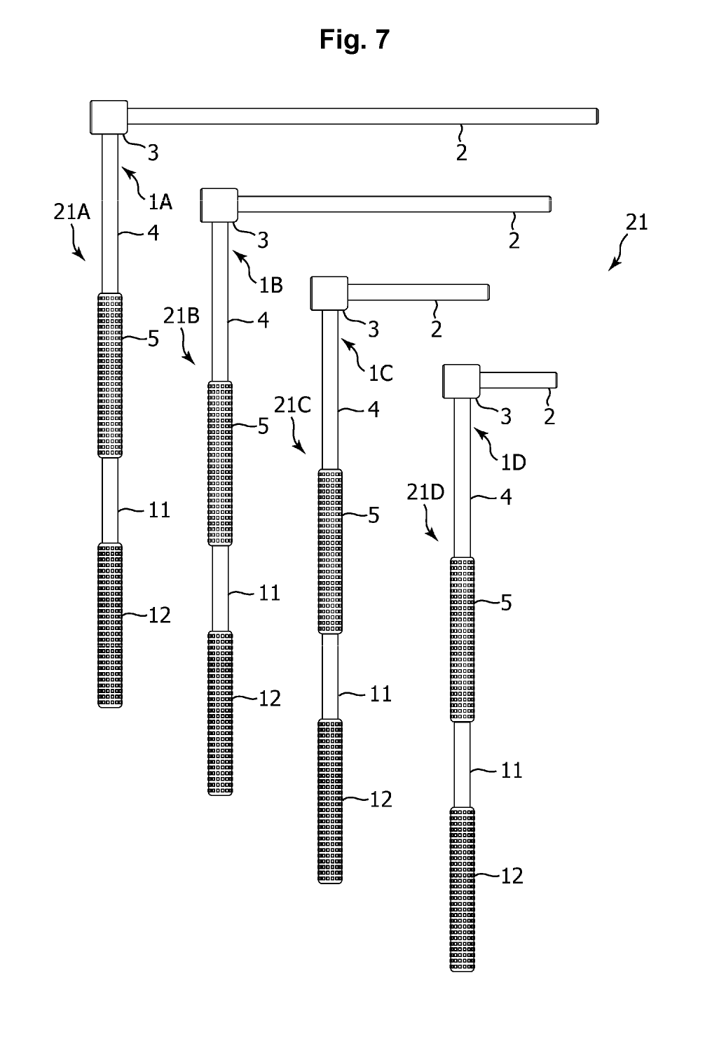

With reference to FIG. 7 to FIG. 12, lateral pin extraction tools 21A to 21D and a lateral pin extraction tool set 21 according to an embodiment 2 of the present invention will be described.

The same elements as those of the lateral pin extraction tools 1A to 1D and the lateral pin extraction tool set 1 according to the aforementioned embodiment 1 will be provided with the same numerical references.

As shown in FIG. 7, the lateral pin extraction tool set 21 according to the embodiment 2 is constituted by the lateral pin extraction tools 21A to 21D, four in total.

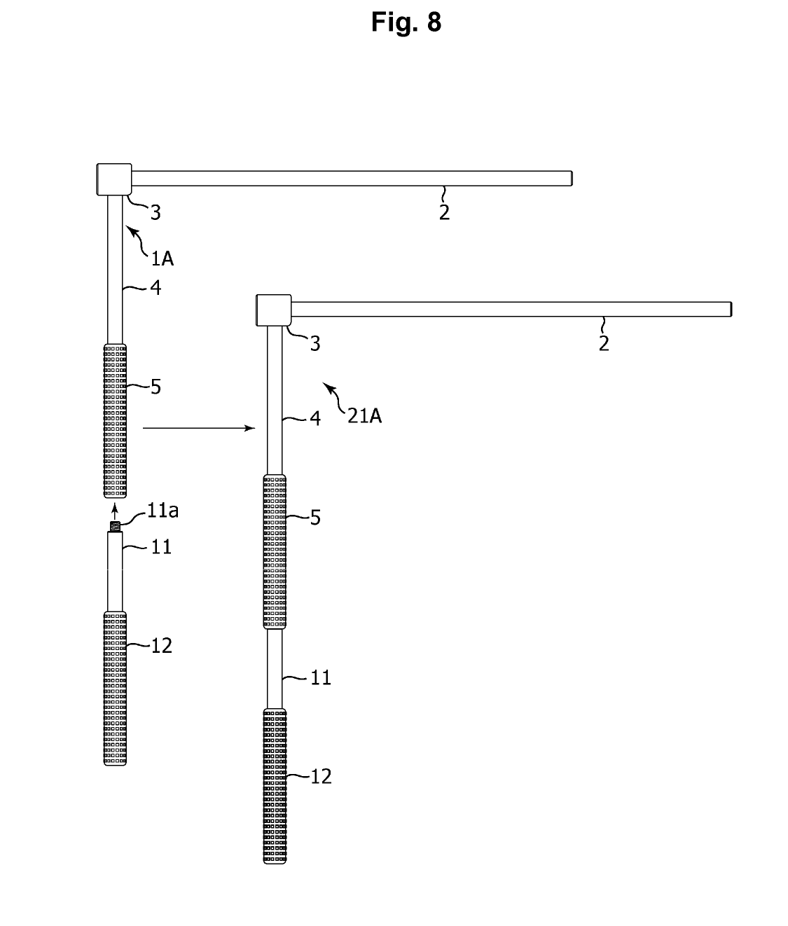

The lateral pin extraction tool 21A shown in FIG. 8 has a construction which can substantially increase the size of the shank element 4 by adding an auxiliary shank element 11 to the shank element 4 of the lateral pin extraction tool 1A shown in FIG. 2.

In other words, the lateral pin extraction tool 21A has a construction which allows the auxiliary shank element 11 to be added by screwing-in an externally threaded part 11a provided for the auxiliary shank element 11 having a slip prevention part 12 into an internally threaded part 4a provided for the shank element 4 of the lateral pin extraction tool 1A.

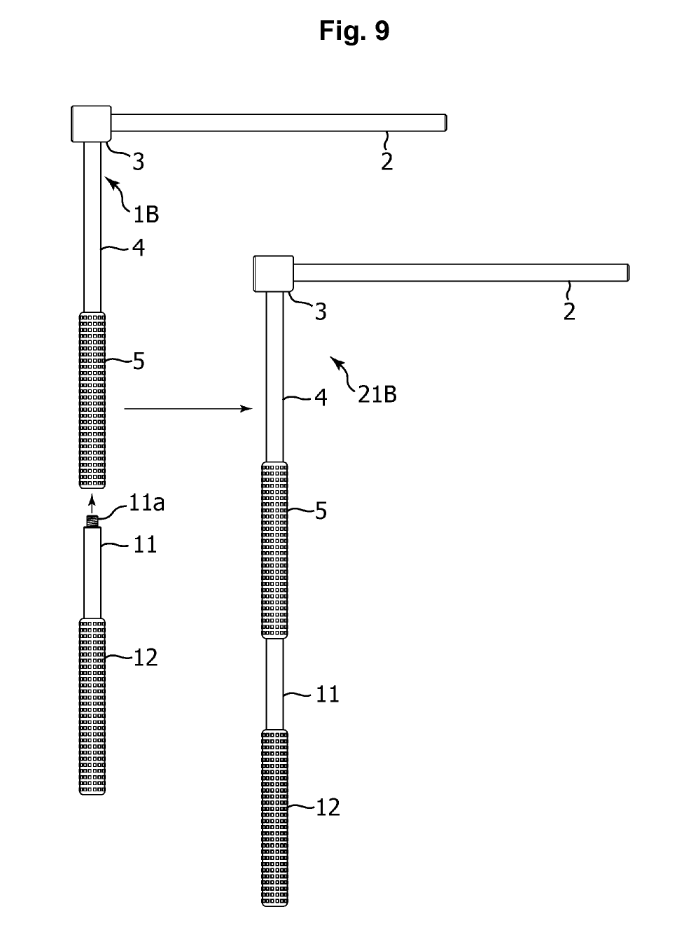

As in the aforementioned case, the lateral pin extraction tool 21B shown in FIG. 9 has a construction which allows the auxiliary shank element 11 to be added by screwing-in an externally threaded part 11a provided for the auxiliary shank element 11 having a slip prevention part 12 into an internally threaded part 4a provided for the shank element 4 of the lateral pin extraction tool 1B.

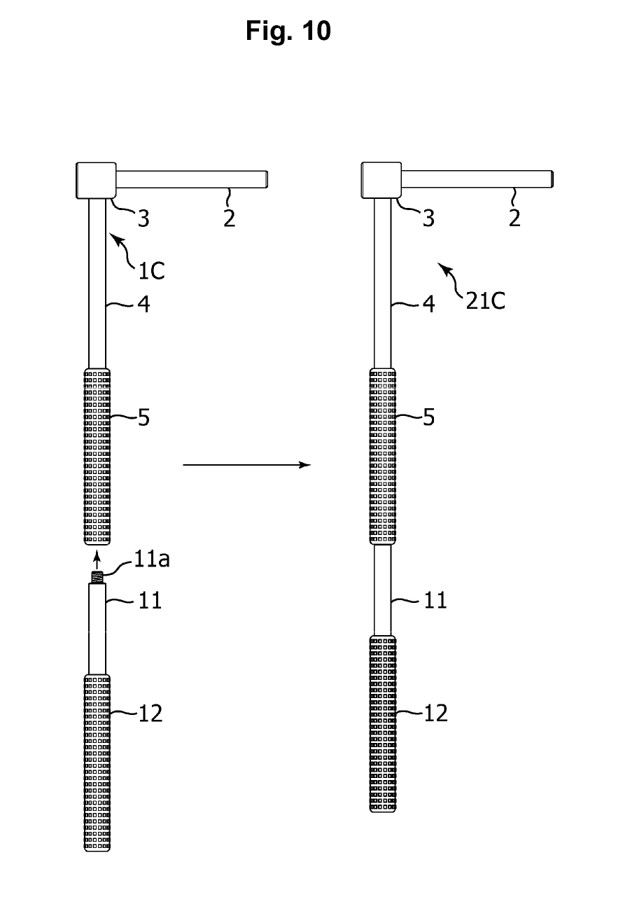

As in the aforementioned case, the lateral pin extraction tool 21C shown in FIG. 10 has a construction which allows the auxiliary shank element 11 to be added by screwing-in an externally threaded part 11a provided for the auxiliary shank element 11 having a slip prevention part 12 into an internally threaded part 4a provided for the shank element 4 of the lateral pin extraction tool 1C.

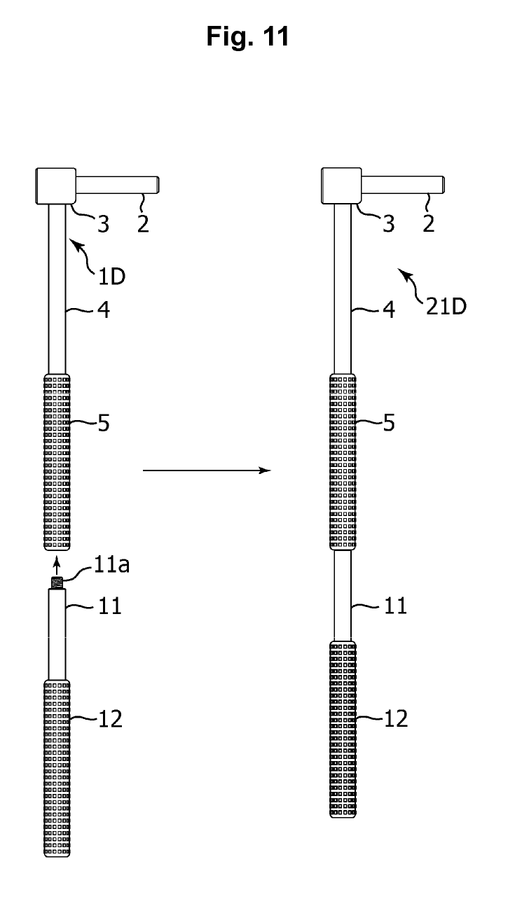

As in the aforementioned case, the lateral pin extraction tool 21D shown in FIG. 11 has a construction which allows the auxiliary shank element 11 to be added by screwing-in an externally threaded part 11a provided for the auxiliary shank element 11 having a slip prevention part 12 into an internally threaded part 4a provided for the shank element 4 of the lateral pin extraction tool 1D.

In this way, with any of the lateral pin extraction tools 21A to 21D according to the embodiment 2, the auxiliary shank element 11 is removably provided to substantially increase the size of the shank element 4 for causing the operator's hand holding location to be altered toward the auxiliary shank element 11, and thereby increasing the spacing between the pertinent operator's face position and the striking block element 3, compared to the respective lateral pin extraction tools 1A to 1D of the embodiment 1.

Also in the embodiment 2, as is the case with the embodiment 1, alternatively to a configuration as illustrated in the figure (a configuration providing an integral part as a whole by welding), the extraction butting element 2, striking block element 3 and shank element 4 may be configured to provide a modification of the embodiment 1 as shown in FIG. 13 by forming the extraction butting element 2 and the shank element 4 of the lateral pin extraction tool as an integral part without the striking block element 3 being provided.

Further, also in the embodiment 2, as is the case with the embodiment 1, alternatively to the configuration of the extraction butting element 2, striking block element 3 (or the portion 30 of the rear end face of the extraction butting element 2 that is struck by the hammer, shown in FIG. 13) and shank element 4 in which the shank element 4 is located approximately just under the striking block element 3 (or the portion 30 of the rear end face of the extraction butting element 2 that is struck by the hammer, shown in FIG. 13) to provide substantially an L-shaped configuration as a whole, as illustrated in the figure, a configuration may be adopted in which, instead of locating the shank element 4 just under the striking block element 3 (or the portion 30 of the rear end face of the extraction butting element 2 that is struck by the hammer, shown in FIG. 13) as illustrated in the figure, the shank element 4 is located, as an integral part as a whole, on the lower end face of the extraction butting element 2 with an appropriate distance being given from the striking block element 3 (or the portion 30 of the rear end face of the extraction butting element 2 that is struck by the hammer, shown in FIG. 13), thus a modified shape of T (not shown) being provided.

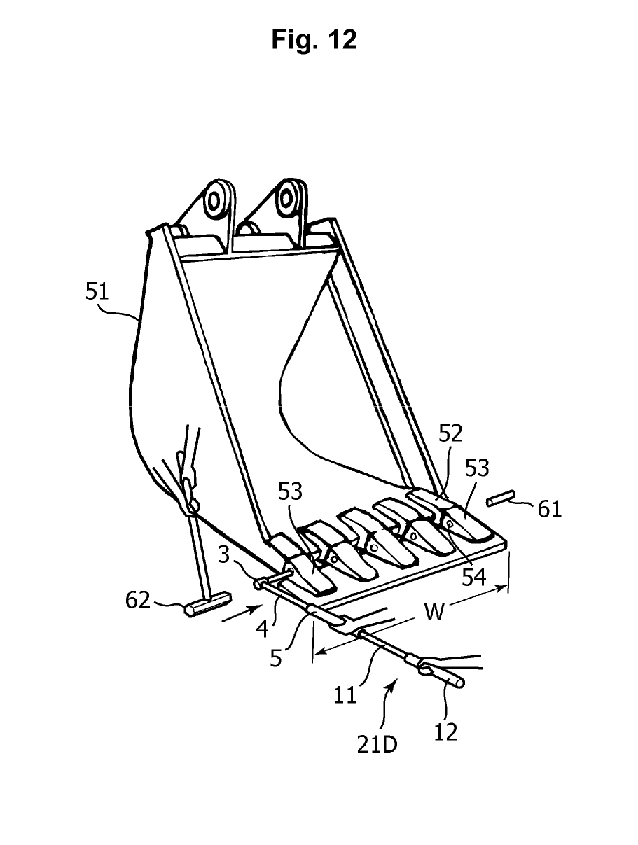

Next, the lateral pin extraction operation using any of the lateral pin extraction tools 21A to 21D according to the embodiment 2 will be described with reference to FIG. 12 (illustrating the operation made by two persons).

In the embodiment 2, in order to extract the lateral pin 61 fitted into the respective lateral holes 54 penetrating the plurality of adapters 52 and the plurality of points 53 in the working machine bucket 51, an appropriate one of the four lateral pin extraction tools 21A to 21D constituting the lateral pin extraction tool set 21 is selected for use.

The criteria for which one of the four lateral pin extraction tools 21A to 21D constituting the lateral pin extraction tool set 21 is to be selected for use are the same as those in the embodiment 1. For example, FIG. 12 illustrates the state in which the operation is made by two persons confronting each other, for example, one operator holding the shank element 4 of the lateral pin extraction tool 21D by both hands, the other operator having the hammer 62 by both hands, and further locating the protrusion end of the extraction butting element 2 of the lateral pin extraction tool 21D in the lateral hole 54 for butting it against the lateral pin 61.

In other words, the protrusion end of the extraction butting element 2 of the lateral pin extraction tool 21D is butted against the end part of the lateral pin 61 fitted into the lateral hole 54.

In this state, the operator uses the hammer 62 to strike the striking block element 3 of the lateral pin extraction tool 21D.

Thereby, the force is transmitted from the striking block element 3 to the extraction butting element 2, the lateral pin 61 in the lateral hole 54 being forced out of this lateral hole 54 to be extracted.

In case where the lateral pin extraction tool 21D is used, the protrusion length L4 of the extraction butting element 2 of this lateral pin extraction tool 21D being short makes the lateral pin extraction tool 21D suitable for extraction of the lateral pin 61 in, for example, one lateral hole 54 in the working machine bucket 51.

On the other hand, the spacing between the position of the operator's face and the striking block element 3 of the lateral pin extraction tool 21D is increased as a result of providing the auxiliary shank element 11, as compared to the lateral pin extraction tool 1D according to the embodiment 1, whereby the safety at the time of striking operation on the lateral pin extraction tool 21D by the hammer 62 is improved. In other words, the spacing between the position of the operator's face and the striking block element 3 being increased further reduces the possibility of that the face may be struck or the glasses may be broken.

In this case, also in the embodiment 2, as is the case with the embodiment 1, after completion of the extraction of the lateral pin 61 in the one lateral hole 54 located on the outermost side in the working machine bucket 51 as described above, the extraction butting element 2 of the lateral pin extraction tool 21C, which is subsequently used, is passed through the pertinent lateral hole 54, which can function as a guide, to extract a second lateral pin 61 and the like, which assures a higher accuracy of the lateral pin extraction operation and a further improvement of the operation efficiency.

This same statement is also true when either of the lateral pin extraction tool 21B and the lateral pin extraction tool 21A is used.

Next, the state in which two persons make operation using the lateral pin extraction tool 21A equipped with the auxiliary shank element 11 will be described.

In this case, one operator holds, for example, the shank element 4 and the auxiliary shank element 11 of the lateral pin extraction tool 21A by both hands, and the other operator has the hammer 62 by both hands, further, passing the protrusion end of the extraction butting element 2 of the lateral pin extraction tool 21A through the respective lateral holes 54 from which the respective lateral pins 61 have been extracted by the lateral pin extraction tools 1D, 1C, and 1B, and then butting the protrusion end of the extraction butting element 2 against the lateral pin 61 to be extracted while making a striking operation on the lateral pin extraction tool 21A by the hammer 62 for extraction of the lateral pin.

In this case, in the same way as in the aforementioned case, the safety at the time of striking operation on the lateral pin extraction tool 21A by the hammer 62 is further improved.

In addition, because the protrusion length L1 of the extraction butting element 2 of the lateral pin extraction tool 21A is extra long, the extraction operation on the five, for example, lateral pins 61 fitted into the respective lateral holes 54 penetrating the five, for example, adapters 52 and points 53, respectively, can be made at a time by means of the lateral pin extraction tool 21A, which allows the operation efficiency to be improved while maintaining the operational safety.

In case where either of the lateral pin extraction tool 21C and the lateral pin extraction tool 21B, which are between the aforementioned lateral pin extraction tool 21D and lateral pin extraction tool 21A, is used, the lateral pin extraction tool 21C, for example, can provide substantially the same functional effects (improvement in safety and accuracy) as is obtained with the lateral pin extraction tool 21D, while the lateral pin extraction tool 21B, for example, can provide substantially the same functional effect (improvement in operation efficiency and safety) as is obtained with the lateral pin extraction tool 21A.

Further, the lateral pin extraction tool set 21 for the working machine bucket 51 according to the embodiment 2 is constituted by the lateral pin extraction tools 21A to 21D, four in total, as shown in FIG. 7, which allows proper selection of lateral pin extraction tool, assuring safety and accuracy of the lateral pin extraction operation, and improvement of the operation efficiency.

Also in the embodiment 2, as is the case with the embodiment 1, for example, in order to extract a first lateral pin 61 (located on the outermost side) of the respective lateral pins 61 fitted into the plurality of lateral holes 54 in the working machine bucket 51, it is advantageous to select the lateral pin extraction tool 21D of the four lateral pin extraction tools 21A to 21D, judging from the relationship between the length of the protrusion length L4 of the extraction butting element 2 and that of the shank element 4; in order to extract a second lateral pin 61 (next to the first lateral pin 61 located on the outermost side) of the respective lateral pins 61 fitted into the plurality of lateral holes 54 in the working machine bucket 51, it is advantageous to select the lateral pin extraction tool 21C of the four lateral pin extraction tools 21A to 21D, judging from the relationship between the length of the protrusion length L3 of the extraction butting element 2 and that of the shank element 4; in order to extract a third lateral pin 61 (next to the second lateral pin 61) of the respective lateral pins 61 fitted into the plurality of lateral holes 54 in the working machine bucket 51, it is advantageous to select the lateral pin extraction tool 21B of the four lateral pin extraction tools 21A to 21D, judging from the relationship between the length of the protrusion length L2 of the extraction butting element 2 and that of the shank element 4; and further, in order to extract a fourth lateral pin 61 (next to the third lateral pin 61) of the respective lateral pins 61 fitted into the plurality of lateral holes 54 in the working machine bucket 51, it is advantageous to select the lateral pin extraction tool 21A of the four lateral pin extraction tools 21A to 21D, judging from the relationship between the length of the protrusion length L1 of the extraction butting element 2 and that of the shank element 4.

In the embodiment 2, the lateral pin extraction tool set 21 is constituted by the lateral pin extraction tools 21A to 21D, four in total, however, the constitution is not restricted to this, and as is the case with the embodiment 1, a lateral pin extraction tool set 21 which is constituted by a desired combination of selections from those can, of course, be provided.

### INDUSTRIAL APPLICABILITY

The lateral pin extraction tools according to the present invention are applicable not only to the above-mentioned working machine bucket for power shovels, shovel loaders, and the like, but also machines and instruments which use a lateral pin connection structure for connecting/disconnecting one member to/from another member as required.

### DESCRIPTION OF SYMBOLS

1: Lateral pin extraction tool set

1A: Lateral pin extraction tool

1B: Lateral pin extraction tool

1C: Lateral pin extraction tool

1D: Lateral pin extraction tool

2: Extraction butting element

3: Striking block element

4: Shank element

4a: Internally threaded part

5: Slip prevention part

10A: Lateral pin extraction tool in modification

11: Auxiliary shank element

11a: Externally threaded part

12: Slip prevention part

21: Lateral pin extraction tool set

21A: Lateral pin extraction tool

21B: Lateral pin extraction tool

21C: Lateral pin extraction tool

21D: Lateral pin extraction tool

30: Portion of rear end face of extraction butting element that is struck by hammer in modification

51: Working machine bucket

52: Adapter

53: Point (including tooth edge)

54: Lateral hole

61: Lateral pin

62: Hammer

L1: Protrusion length

L2: Protrusion length

L3: Protrusion length

L4: Protrusion length

W: Arrangement width

1. A lateral pin extraction tool for extracting a lateral pin fitted into respective lateral holes penetrating a plurality of adapters and a plurality of points, respectively, in a working machine bucket, comprising:
an extraction butting element, the distal end thereof being butted against the end part of the lateral pin fitted into said lateral hole while, under the striking force from the struck rear end face thereof, being inserted into the lateral hole for extracting the lateral pin fitted into the lateral hole; and
a shank element for grip being integrally formed or integrally mounted in any location around the struck rear end face of said extraction butting element, having a slip prevention part in the end part, and being configured extra long as a whole,
the protrusion length of said extraction butting element from the struck rear end face thereof being set at any of a plurality of grades of length from longest to shortest in the range of the arrangement width for a plurality of adapters in said working machine bucket, preferably, any of four grades of length from longest to shortest consisting of a grade of length allowing insertion into the respective lateral holes in all the adapters and points; a grade of length allowing insertion into the respective lateral holes of three or four adapters and points; a grade of length allowing insertion into the respective lateral holes of two adapters and points; and a grade of length allowing insertion into the lateral hole of one adapter and point.

2. A lateral pin extraction tool for extracting a lateral pin fitted into respective lateral holes penetrating a plurality of adapters and a plurality of points, respectively, in a working machine bucket, comprising:
an extraction butting element, the distal end thereof being butted against the end part of the lateral pin fitted into said lateral hole while, under the striking force from the struck rear end face thereof, being inserted into the lateral hole for extracting the lateral pin fitted into the lateral hole; and
a shank element for grip being integrally formed or integrally mounted in any location around the struck rear end face of said extraction butting element, having a slip prevention part in the end part, and being configured extra long as a whole,
the protrusion length of said extraction butting element from the struck rear end face thereof being set at any of lengths, i.e., extra long, long, medium, and short lengths in the range substantially equivalent to the arrangement width for a plurality of adapters in said working machine bucket, preferably, any of lengths, i.e., an extra long length defined as a grade of length allowing insertion into the respective lateral holes in all the adapters and points; a long length defined as a grade of length allowing insertion into the respective lateral holes of three or four adapters and points; a medium length defined as a grade of length allowing insertion into the respective lateral holes of two adapters and points; and a short length defined as a grade of length allowing insertion into the lateral hole of one adapter and point.

3. A lateral pin extraction tool for extracting a lateral pin fitted into respective lateral holes penetrating a plurality of adapters and a plurality of points, respectively, in a working machine bucket, comprising:
an extraction butting element, the distal end thereof being butted against the end part of the lateral pin fitted into said lateral hole while, under the striking force from the struck rear end face thereof, being inserted into the lateral hole for extracting the lateral pin fitted into the lateral hole; and
a shank element for grip being integrally formed or integrally mounted in any location around the struck rear end face of said extraction butting element, having a slip prevention part in the end part, and being configured extra long as a whole, and an auxiliary shank element equipped with a slip prevention part for increasing the shank length, being removably mounted to this shank element,
the protrusion length of said extraction butting element from the struck rear end face thereof being set at any of lengths, i.e., extra long, long, medium, and short lengths in the range substantially equivalent to the arrangement width for a plurality of adapters in said working machine bucket, preferably, any of lengths, i.e., an extra long length defined as a grade of length allowing insertion into the respective lateral holes in all the adapters and points; a long length defined as a grade of length allowing insertion into the respective lateral holes of three or four adapters and points; a medium length defined as a grade of length allowing insertion into the respective lateral holes of two adapters and points; and a short length defined as a grade of length allowing insertion into the lateral hole of one adapter and point.

4. A lateral pin extraction tool set constituted by a collection of a plurality of lateral pin extraction tools for extracting respective lateral pins fitted into respective lateral holes penetrating a plurality of adapters and a plurality of points, respectively, in a working machine bucket, comprising:
an extraction butting element, the distal end thereof being butted against the end part of the lateral pin fitted into said lateral hole while, under the striking force from the struck rear end face thereof, being inserted into the lateral hole for extracting the lateral pin fitted into the lateral hole; and
a shank element for grip being integrally formed or integrally mounted in any location around the struck rear end face of said extraction butting element, having a slip prevention part in the end part, and being configured extra long as a whole,
the protrusion length of said respective extraction butting elements from the struck rear end face thereof being set at any of a plurality of grades of length from longest to shortest in the range substantially equivalent to the arrangement width for a plurality of adapters in said working machine bucket, preferably, any of four grades of length from longest to shortest consisting of a grade of length allowing insertion into the respective lateral holes in all the adapters and points; a grade of length allowing insertion into the respective lateral holes of three or four adapters and points; a grade of length allowing insertion into the respective lateral holes of two adapters and points; and a grade of length allowing insertion into the lateral hole of one adapter and point.

5. A lateral pin extraction tool set constituted by a collection of a plurality of lateral pin extraction tools for extracting respective lateral pins fitted into respective lateral holes penetrating a plurality of adapters and a plurality of points, respectively, in a working machine bucket, comprising:
an extraction butting element, the distal end thereof being butted against the end part of the lateral pin fitted into said lateral hole while, under the striking force from the struck rear end face thereof, being inserted into the lateral hole for extracting the lateral pin fitted into the lateral hole; and
a shank element for grip being integrally formed or integrally mounted in any location around the struck rear end face of said extraction butting element, having a slip prevention part in the end part, and being configured extra long as a whole,
the lateral pin extraction tool set being constituted by a collection of four lateral pin extraction tools, the protrusion length of said respective extraction butting elements from the struck rear end face thereof being set at any of lengths, i.e., extra long, long, medium, and short lengths in the range substantially equivalent to the arrangement width for a plurality of adapters in said working machine bucket, preferably, any of lengths, i.e., an extra long length defined as a grade of length allowing insertion into the respective lateral holes in all the adapters and points; a long length defined as a grade of length allowing insertion into the respective lateral holes of three or four adapters and points; a medium length defined as a grade of length allowing insertion into the respective lateral holes of two adapters and points; and a short length defined as a grade of length allowing insertion into the lateral hole of one adapter and point.

6. A lateral pin extraction tool set constituted by a collection of a plurality of lateral pin extraction tools for extracting respective lateral pins fitted into respective lateral holes penetrating a plurality of adapters and a plurality of points, respectively, in a working machine bucket, comprising:
an extraction butting element, the distal end thereof being butted against the end part of the lateral pin fitted into said lateral hole while, under the striking force from the struck rear end face thereof, being inserted into the lateral hole for extracting the lateral pin fitted into the lateral hole;
a striking block element integrally provided at the proximal end of said extraction butting element for receiving the striking force to transmit it to said extraction butting element; and
a shank element for grip being integrally formed or integrally mounted in any location around the struck rear end face of said extraction butting element, having a slip prevention part in the end part, and being configured extra long as a whole, and an auxiliary shank element equipped with a slip prevention part for increasing the shank length, being removably mounted to this shank element,
the lateral pin extraction tool set being constituted by a collection of four lateral pin extraction tools, the protrusion length of said respective extraction butting elements from the struck rear end face thereof being set at any of lengths, i.e., extra long, long, medium, and short lengths in the range substantially equivalent to the arrangement width for a plurality of adapters in said working machine bucket, preferably, any of lengths, i.e., an extra long length defined as a grade of length allowing insertion into the respective lateral holes in all the adapters and points; a long length defined as a grade of length allowing insertion into the respective lateral holes of three or four adapters and points; a medium length defined as a grade of length allowing insertion into the respective lateral holes of two adapters and points; and a short length defined as a grade of length allowing insertion into the lateral hole of one adapter and point.

7. A lateral pin extraction tool for extracting a lateral pin fitted into respective lateral holes penetrating a plurality of adapters and a plurality of points, respectively, in a working machine bucket, comprising:
an extraction butting element, the distal end thereof being butted against the end part of the lateral pin fitted into said lateral hole while, under the striking force, being inserted into the lateral hole for extracting the lateral pin fitted into the lateral hole;
a striking block element integrally provided at the proximal end of said extraction butting element for receiving the striking force to transmit it to said extraction butting element; and
a shank element for grip being integrally mounted to said striking block element, having a slip prevention part in the end part, and being configured extra long as a whole,
the protrusion length of said extraction butting element from the striking block element being set at any of a plurality of grades of length from longest to shortest in the range of the arrangement width for a plurality of adapters in said working machine bucket, preferably, any of four grades of length from longest to shortest consisting of a grade of length allowing insertion into the respective lateral holes in all the adapters and points; a grade of length allowing insertion into the respective lateral holes of three or four adapters and points; a grade of length allowing insertion into the respective lateral holes of two adapters and points; and a grade of length allowing insertion into the lateral hole of one adapter and point.

8. A lateral pin extraction tool for extracting a lateral pin fitted into respective lateral holes penetrating a plurality of adapters and a plurality of points, respectively, in a working machine bucket, comprising:
an extraction butting element, the distal end thereof being butted against the end part of the lateral pin fitted into said lateral hole while, under the striking force, being inserted into the lateral hole for extracting the lateral pin fitted into the lateral hole;
a striking block element integrally provided at the proximal end of said extraction butting element for receiving the striking force to transmit it to said extraction butting element; and
a shank element for grip being integrally mounted to said striking block element, having a slip prevention part in the end part, and being configured extra long as a whole,
the protrusion length of said extraction butting element from the striking block element being set at any of lengths, i.e., extra long, long, medium, and short lengths in the range substantially equivalent to the arrangement width for a plurality of adapters in said working machine bucket, preferably, any of lengths, i.e., an extra long length defined as a grade of length allowing insertion into the respective lateral holes in all the adapters and points; a long length defined as a grade of length allowing insertion into the respective lateral holes of three or four adapters and points; a medium length defined as a grade of length allowing insertion into the respective lateral holes of two adapters and points; and a short length defined as a grade of length allowing insertion into the lateral hole of one adapter and point.

9. A lateral pin extraction tool for extracting a lateral pin fitted into respective lateral holes penetrating a plurality of adapters and a plurality of points, respectively, in a working machine bucket, comprising:
an extraction butting element, the distal end thereof being butted against the end part of the lateral pin fitted into said lateral hole while, under the striking force, being inserted into the lateral hole for extracting the lateral pin fitted into the lateral hole;
a striking block element integrally provided at the proximal end of said extraction butting element for receiving the striking force to transmit it to said extraction butting element; and
a shank element for grip being integrally mounted to said striking block element, having a slip prevention part in the end part, and being configured extra long as a whole, and an auxiliary shank element equipped with a slip prevention part for increasing the shank length, being removably mounted to this shank element,
the protrusion length of said extraction butting element from the striking block element being set at any of lengths, i.e., extra long, long, medium, and short lengths in the range substantially equivalent to the arrangement width for a plurality of adapters in said working machine bucket, preferably, any of lengths, i.e., an extra long length defined as a grade of length allowing insertion into the respective lateral holes in all the adapters and points; a long length defined as a grade of length allowing insertion into the respective lateral holes of three or four adapters and points; a medium length defined as a grade of length allowing insertion into the respective lateral holes of two adapters and points; and a short length defined as a grade of length allowing insertion into the lateral hole of one adapter and point.

10. A lateral pin extraction tool set constituted by a collection of a plurality of lateral pin extraction tools for extracting respective lateral pins fitted into respective lateral holes penetrating a plurality of adapters and a plurality of points, respectively, in a working machine bucket, comprising:
an extraction butting element, the distal end thereof being butted against the end part of the lateral pin fitted into said lateral hole while, under the striking force, being inserted into the lateral hole for extracting the lateral pin fitted into the lateral hole;
a striking block element integrally provided at the proximal end of said extraction butting element for receiving the striking force to transmit it to said extraction butting element; and
a shank element for grip being integrally mounted to said striking block element, having a slip prevention part in the end part, and being configured extra long as a whole,
the protrusion length of said respective extraction butting elements from the striking block element being set at any of a plurality of grades of length from longest to shortest in the range substantially equivalent to the arrangement width for a plurality of adapters in said working machine bucket, preferably, any of four grades of length from longest to shortest consisting of a grade of length allowing insertion into the respective lateral holes in all the adapters and points; a grade of length allowing insertion into the respective lateral holes of three or four adapters and points; a grade of length allowing insertion into the respective lateral holes of two adapters and points; and a grade of length allowing insertion into the lateral hole of one adapter and point.

11. A lateral pin extraction tool set constituted by a collection of a plurality of lateral pin extraction tools for extracting respective lateral pins fitted into respective lateral holes penetrating a plurality of adapters and a plurality of points, respectively, in a working machine bucket, comprising:
an extraction butting element, the distal end thereof being butted against the end part of the lateral pin fitted into said lateral hole while, under the striking force, being inserted into the lateral hole for extracting the lateral pin fitted into the lateral hole;
a striking block element integrally provided at the proximal end of said extraction butting element for receiving the striking force to transmit it to said extraction butting element; and
a shank element for grip being integrally mounted to said striking block element, having a slip prevention part in the end part, and being configured extra long as a whole,
the lateral pin extraction tool set being constituted by a collection of four lateral pin extraction tools, the protrusion length of said respective extraction butting elements from the striking block element being set at any of lengths, i.e., extra long, long, medium, and short lengths in the range substantially equivalent to the arrangement width for a plurality of adapters in said working machine bucket, preferably, any of lengths, i.e., an extra long length defined as a grade of length allowing insertion into the respective lateral holes in all the adapters and points; a long length defined as a grade of length allowing insertion into the respective lateral holes of three or four adapters and points; a medium length defined as a grade of length allowing insertion into the respective lateral holes of two adapters and points; and a short length defined as a grade of length allowing insertion into the lateral hole of one adapter and point.

12. A lateral pin extraction tool set constituted by a collection of a plurality of lateral pin extraction tools for extracting respective lateral pins fitted into respective lateral holes penetrating a plurality of adapters and a plurality of points, respectively, in a working machine bucket, comprising:
an extraction butting element, the distal end thereof being butted against the end part of the lateral pin fitted into said lateral hole while, under the striking force, being inserted into the lateral hole for extracting the lateral pin fitted into the lateral hole;
a striking block element integrally provided at the proximal end of said extraction butting element for receiving the striking force to transmit it to said extraction butting element; and
a shank element for grip being integrally mounted to said striking block element, having a slip prevention part in the end part, and being configured extra long as a whole, and an auxiliary shank element equipped with a slip prevention part for increasing the shank length, being removably mounted to this shank element,
the lateral pin extraction tool set being constituted by a collection of four lateral pin extraction tools, the protrusion length of said respective extraction butting elements from the striking block element being set at any of lengths, i.e., extra long, long, medium, and short lengths in the range substantially equivalent to the arrangement width for a plurality of adapters in said working machine bucket, preferably, any of lengths, i.e., an extra long length defined as a grade of length allowing insertion into the respective lateral holes in all the adapters and points; a long length defined as a grade of length allowing insertion into the respective lateral holes of three or four adapters and points; a medium length defined as a grade of length allowing insertion into the respective lateral holes of two adapters and points; and a short length defined as a grade of length allowing insertion into the lateral hole of one adapter and point.
